(19) United States
(12) Patent Application Publication
(10) Pub. No.: US 2010/0180276 A1
(43) Pub. Date: Jul. 15, 2010

(54) APPLICATION PARTITIONING ACROSS A VIRTUALIZED ENVIRONMENT

(76) Inventor: Azeem S. Jiva, Austin, TX (US)

Correspondence Address: MHKKG / GLOBALFOUNDRIES, P.O. Box 398, Austin, TX, 78767-0698, US

(21) Appl. No.: 12/354,435

(22) Filed: Jan. 15, 2009

(51) Int. Cl. G06F 9/455

(52) U.S. Cl. 718/1

(57) ABSTRACT

A processor including an execution core for executing instructions. In one embodiment, the instructions cause the core to enable two or more virtual machine guests to execute under the control of a virtual machine monitor. A first virtual machine guest includes a first portion of an application executing in the context of a first guest operating system. The first portion of the application creates a guest virtual machine applet that executes in the context of a second virtual machine guest. The first portion of the application and the guest virtual machine applet are part of a single application. To create a guest virtual machine applet, the first portion of the application executes a call to the first guest operating system and in response to receiving the call from the first portion of the application, the first guest operating system makes a system call to the virtual machine monitor.

### BACKGROUND OF THE INVENTION

1. Field of the Invention

This invention relates to virtual machines in computer systems and, more particularly, to partitioning applications in a virtualized environment.

2. Description of the Related Art

Virtualization has been used in computer systems for a variety of different purposes. For example, virtualization can be used to execute privileged software in a “container” to prevent the privileged software from directly accessing and/or making changes to at least some of the physical machine state without first being permitted to do so by a virtual machine monitor (VMM) that controls the virtual machine. Such a container can prevent “buggy” or malicious software from causing problems on the physical machine. Additionally, virtualization can be used to permit two or more privileged programs to execute on the same physical machine concurrently. The privileged programs can be prevented from interfering with each other since access to the physical machine is controlled. Privileged programs may include operating systems, and may also include other software that expects to have full control of the hardware on which the software is executing. In another example, virtualization can be used to execute a privileged program on hardware that differs from the hardware expected by the privileged program.

Generally, virtualization of a processor or computer system may include providing one or more privileged programs with access to a virtual machine (the container mentioned above) over which the privileged program has full control, but the control of the physical machine is retained by the VMM. The virtual machine may include a processor (or processors), memory, and various peripheral devices that the privileged program expects to find in the machine on which it is executing. The virtual machine elements may be implemented by hardware that the VMM allocates to the virtual machine, at least temporarily, and/or may be emulated in software. Each privileged program (and related software in some cases, such as the applications that execute on an operating system) may be referred to herein as a guest. Virtualization may be implemented in software (e.g. the VMM mentioned above) without any specific hardware virtualization support in the physical machine on which the VMM and its virtual machines execute. However, virtualization may be simplified and/or achieve higher performance if some hardware support is provided.

In order to maintain control over the physical machine, the VMM may intercept various events that occur during guest execution. For example, the events may include certain instructions that access privileged state, as well as certain exception/interrupt events. In cases in which a guest is virtual machine “aware,” the privileged code in the virtual machine may make a call to the VMM. In response to an intercept or call, switching between execution of the VMM and the execution of guests occurs.

Even though virtualization can isolate privileged programs like operating systems, applications that run on top of an operating system generally execute within the confines of a single operating system. Consequently, both secure and insecure portions of an application can interact in the same environment. Faulty and/or malicious portions of an application may disrupt the operation of other portions of the application, negating the isolation advantages of the virtual machine. In addition, failure of a given operating system affects all components that are in the given operating system's domain. Further, communication between applications across operating system boundaries may require the use of slow and cumbersome network calls. In view of the above limitations, what is needed are improved system and methods for taking advantage of the isolation properties offered by virtual machines.

### SUMMARY OF THE INVENTION

Various embodiments of processor including an execution core configured to execute instructions are disclosed. In one embodiment, the instructions cause the core to enable two or more virtual machine guests to execute under the control of a virtual machine monitor. A first virtual machine guest includes a first portion of an application executing in the context of a first guest operating system. The first portion of the application creates a guest virtual machine applet that executes in the context of a second virtual machine guest. The first portion of the application and the guest virtual machine applet are part of a single application.

In one embodiment, to create a guest virtual machine applet, the first portion of the application executes a call to the first guest operating system and in response to receiving the call from the first portion of the application, the first guest operating system makes a system call to the virtual machine monitor. In a further embodiment, the guest virtual machine applet remains operating without interruption throughout a reboot of the first guest operating system.

In a still further embodiment, the guest virtual machine applet includes executable code that is associated with the single application. In a still further embodiment, a second virtual machine guest executes a second portion of the application in the context of a second guest operating system and the first and second portions of the application share executable code within the guest virtual machine applet.

In another embodiment, the guest virtual machine applet includes data storage that is associated with the single application. In a further embodiment, a second virtual machine guest executes a second portion of the application in the context of a second guest operating system and the first and second portions of the application share data stored by the guest virtual machine applet.

### BRIEF DESCRIPTION OF THE DRAWINGS

FIG. 1 is a block diagram of one embodiment of a computer system that implements virtualization.

FIG. 2 illustrates a more detailed embodiment of computer system including two guests.

FIG. 3 illustrates one embodiment of a process that may be used to create a VMLET.

FIG. 4 illustrates one embodiment of computer system that uses virtualization and a VMLET to share a region of memory between applications executing in different OS contexts.

FIG. 5 illustrates one embodiment of computer system that uses virtualization and VMLETs to share code between different applications.

FIG. 6 illustrates one embodiment of a process 600 that may be used to access VMLETs in a virtualized environment.

FIG. 7 is a block diagram of a computer accessible storage medium.

While the invention is susceptible to various modifications and alternative forms, specific embodiments are shown by way of example in the drawings and are herein described in detail. It should be understood, however, that drawings and detailed descriptions thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION

### Virtualization Overview

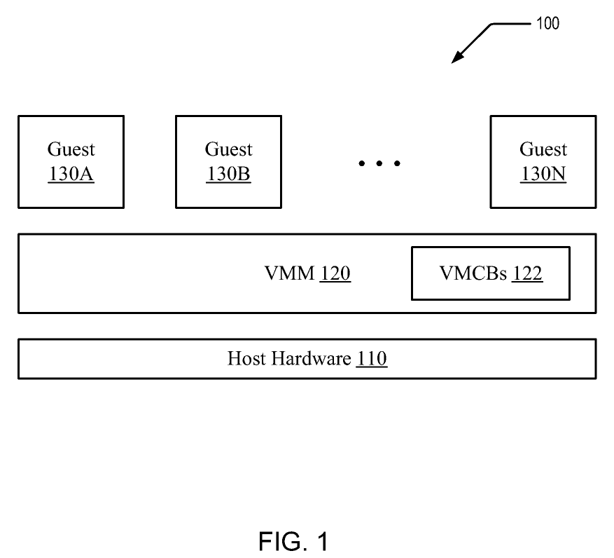

Turning now to FIG. 1, a block diagram of one embodiment of a computer system 100 that implements virtualization is shown. In the embodiment of FIG. 1, system 100 includes host hardware 110, a virtual machine manager (VMM) 120 and multiple guests 130A-130N. The guests 130A-130N are managed by VMM 120. The VMM 18 and the guests 130A-130N execute on host hardware 110, which may comprise the physical hardware included in the computer system 100. Generally, a “guest” may comprise any one or more software programs that are to be virtualized for execution in the computer system 100. A guest may include at least some code that executes in privileged mode, and thus expects to have full control over the computer system on which it is executing. In one embodiment, the VMM 120 may maintain a set of virtual machine control blocks (VMCBs) 122. There may be one VMCB 122 for each guest 130A-130N. While the VMCBs 122 are shown as part of the VMM 120 for illustration in FIG. 1, the VMCBs 122 may be stored in memory and/or on non-volatile media such as disk drives in the host hardware 120. It is noted that the letter “N” when used herein in reference numerals such as 130N is meant to generically indicate any number of elements bearing that reference numeral (e.g. any number of guests 130A-130N, including one guest).

The host hardware 110 generally includes all of the hardware included in the computer system 100. In various embodiments, the host hardware 110 may include one or more processors, memory, peripheral devices, and other circuitry used to couple the preceding components. For example, common personal computer (PC)-style systems may include a Northbridge coupling the processors, the memory, and a graphics device that uses the advanced graphic port (AGP) interface. Additionally, the Northbridge may couple to a peripheral bus such as the peripheral component interface (PCI) bus, to which various peripheral components may be directly or indirectly coupled. A Southbridge may also be included, coupled to the PCI bus, to provide legacy functionality and/or couple to legacy hardware. In other embodiments, other circuitry may be used to link various hardware components. For example, HyperTransport™ (HT) links may be used to link nodes, each of which may include one or more processors, a host bridge, and a memory controller. The host bridge may be used to couple, via HT links, to peripheral devices in a daisy chain fashion. Any desired circuitry/host hardware structure may be used.

The VMM 120 may be configured to provide the virtualization for each of the guests 130A-130N, and may control the access of the guests 130A-130N to the host hardware 110. The VMM 120 may also be responsible for scheduling the guests 130A-130N for execution on the host hardware 110. In some embodiments, one or more components of the host hardware may include hardware support for virtualization. The VMM 120 may be configured to use the hardware support provided in the host hardware 110 for virtualization.

In some embodiments, the VMM 120 may be integrated into or execute on a host OS. In such embodiments, the VMM 120 may rely on the host OS, including any drivers in the host OS, platform system management mode (SMM) code provided by the system BIOS, etc. Thus, the host OS components (and various lower-level components such as the platform SMM code) execute directly on the host hardware 110 and are not virtualized by the VMM 120. The VMM 120 and the host OS (if included) may together be referred to as the “host”, in such embodiments. In other embodiments, the VMM 120 may be implemented as a “thin” standalone software program that executes on a host operating system (not shown), which in turn executes on the host hardware 110 and provides the virtualization for the guests 130A-130N. In any of the above embodiments, the VMM may sometimes be referred to as a “hypervisor.” To simplify the discussions that follow, the VMM 120 may be shown at a level just above the host hardware implying that VMM 120 includes a host operating system. However, alternative embodiments in which VMM 120 and a host OS are separate and VMM 120 operates at a level just above the host operating system are also possible and are contemplated.

In various embodiments, the VMM 120 may support full virtualization, para-virtualization, or both. Furthermore, in some embodiments, the VMM 120 may concurrently execute guests that are paravirtualized and guests that are fully virtualized.

With full virtualization, the guest 130A-130N is not aware that virtualization is occurring. Each guest 130A-130N may have contiguous, zero based memory in its virtual machine, and the VMM 120 may use shadow page tables or nested page tables to control access to the host physical address space. The shadow page tables may remap from guest virtual addresses to host physical addresses (effectively remapping the guest “physical address” assigned by memory management software in the guest 130A-130N to host physical address), while nested page tables may receive the guest physical address as an input and map to the host physical address. Using the shadow page tables or nested page tables for each guest 130A-130N, the VMM 120 may ensure that guests do not access other guests' physical memory in the host hardware 110. In one embodiment, in full virtualization, guests 130A-130N do not directly interact with the peripheral devices in the host hardware 110.

With para-virtualization, guests 130A-130N may be at least partially VM-aware. Such guests 130A-130N may negotiate for memory pages with the VMM 120, and thus remapping guest physical addresses to host physical addresses may not be required. In one embodiment, in paravirtualization, guests 130A-130N may be permitted to directly interact with peripheral devices in the host hardware 110. At any given time, a peripheral device may be “owned” by a guest or guests 130A-130N. In one implementation, for example, a peripheral device may be mapped into a protection domain with one or more guests 130A-130N that currently own that peripheral device. Only guests that own a peripheral device may directly interact with it. There may also be a protection mechanism to prevent devices in a protection domain from reading/writing pages allocated to a guest in another protection domain.

As mentioned previously, the VMM 120 may maintain a VMCB 122 for each guest 130A-130N. The VMCB 122 may generally comprise a data structure stored in a storage area that is allocated by the VMM 120 for the corresponding guest 130A-130N. In one embodiment, the VMCB 122 may comprise a page of memory, although other embodiments may use larger or smaller memory areas and/or may use storage on other media such as non-volatile storage. In one embodiment, the VMCB 122 may include the guest's processor state, which may be loaded into a processor in the host hardware 110 when the guest is scheduled to execute and may be stored back to the VMCB 122 when the guest exits (either due to completing its scheduled time, or due to one or more intercepts that the processor detects for exiting the guest). In some embodiments, only a portion of the processor state is loaded via the instruction that transfers control to the guest corresponding to the VMCB 122 (the “Virtual Machine Run (VMRUN)” instruction), and other desired state may be loaded by the VMM 120 prior to executing the VMRUN instruction. Similarly, in such embodiments, only a portion of the processor state may be stored to the VMCB 122 by the processor on guest exit and the VMM 120 may be responsible for storing any additional state as needed. In other embodiments, the VMCB 122 may include a pointer to another memory area where the processor state is stored. Furthermore, in one embodiment, two or more exit mechanisms may be defined. In one embodiment, the amount of state stored and the location of state that is loaded may vary depending on which exit mechanism is selected.

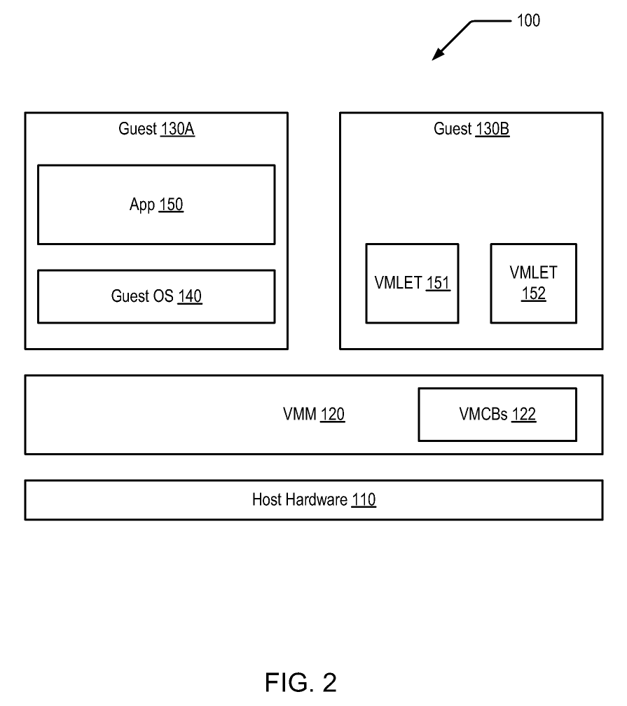

FIG. 2 illustrates a more detailed embodiment of computer system 100 including two guests, 130A and 130B. As shown guest 130A includes a guest operating system (OS) 140 and an application 150 that runs on the guest OS 140. Guest 130B includes virtual machine applets (VMLETs) 151 and 152. The guest OS 140 may be any OS, such as any of the Windows OSs available from Microsoft Corp., (Redmond, Wash.), any UNIX-type operating system such as Linux, AIX from IBM Corporation (Armonk, N.Y.), Solaris from Sun Microsystems, Inc. (Santa Clara, Calif.), HP-UX from Hewlett-Packard Company (Palo Alto, Calif.), etc. The guest 130B is an example of a guest that comprises non-OS code such as VMLETs 151 and 152. In alternative embodiments, any number of applications instead of or in addition to application 150 may run on guest OS 140, and guest 130B may comprise any number of VMLETs or other applications instead of or in addition to VMLETs 151 and 152, depending on the availability of resources provided by VMM 120.

During operation, application 150 may create one or more virtual machine applets that run in a different guest environment, such as VMLETs 151 and 152. As used herein, a VMLET refers to any portion of code and/or memory space that is associated with or owned by a host application but executes in a different guest context of or is controlled by a different guest context from the guest context of the host application. VMLETs 151 and 152 may be referred to as guest portions of the host application 150. Guest portions of an application may be protected from other running guest portions via VMM 120. Host application 150 may create as many VMLETs as available system resources allow. Host application 150 may create different VMLETs to handle different functions of the overall application including storing data and performing various executable functions. In one embodiment, host application 150 may create a VMLET through a service provided by its guest OS that forwards creation requests to the VMM to create the VMLET. For example, guest 130A and guest OS 140 may be aware of the existence of the virtualized environment and VMM 120, such as in para-virtualization as described above.

The following pseudo code illustrates one example of the call used to create a VMLET that includes an executable function.
//Create a VMLET with a fixed size and a function pointer for the function to be run Handle* my_vmlet=create_vmlet(int sizeOfVmletInBytes, void* func_ptr);

The following pseudo code illustrates one example of the call used to create a VMLET that may be used to store data.

//Create a VMLET with a fixed size for data storage
Handle* my_vmlet = create_vmlet(int sizeOfVmletInBytes);

Application 150 may execute either of the above calls, which, in one embodiment, may be handed down from OS 140 to VMM 120, VMM 120 may then create a section of memory of the size request by the create_vmlet( ) call. The function pointer func_ptr may be passed back to the calling method as a handle for execution of custom functions. By having the VMLET execute these functions, both OS140 and application 150 remain protected from any adverse effects the functions may cause.

In a further embodiment, application 150 may store data in the VMLET that may be shared with other applications. Applications that share data may execute in the context of a single OS or in multiple OS contexts. In one embodiment, VMLETs may be used to enable multiple OSs to communicate with each other. In another embodiment, VMLETs may be used to enable high performance or high availability applications to share OS memory at OS layer, rather than sharing memory at the application layer.

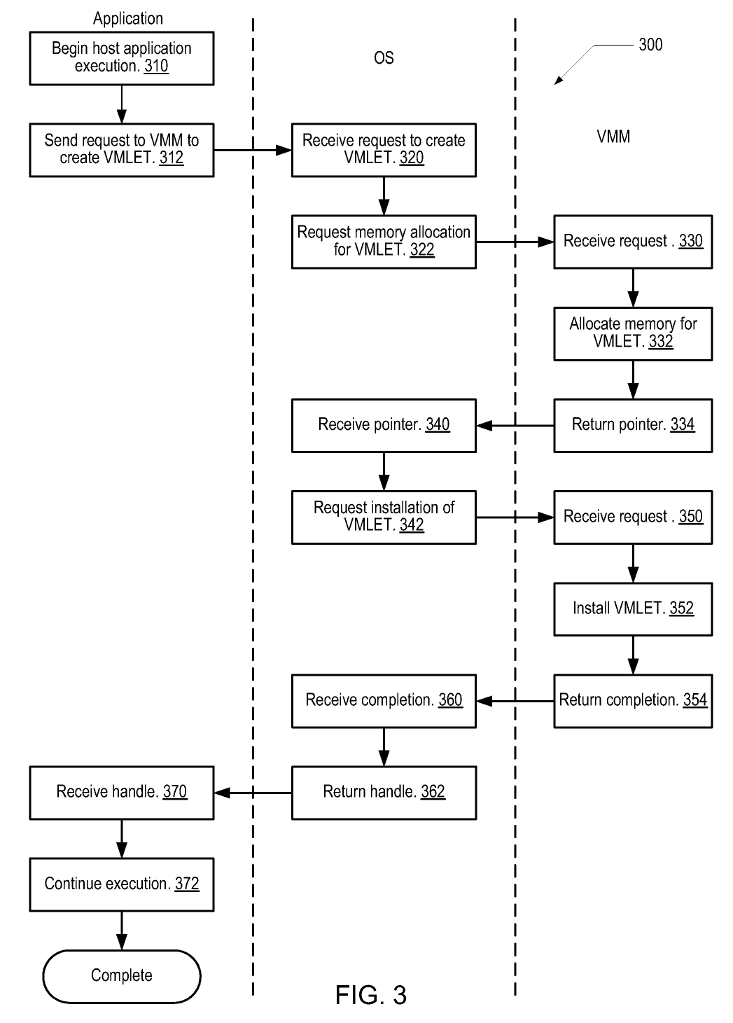

FIG. 3 illustrates one embodiment of a process that may be used to create a VMLET. Process 300 may begin when a host application begins executing (block 310). At some point during execution, the host application may send a request to a VMM to create a VMLET (block 312). The OS on top of which the application is running may intercept the request (block 320) and forward a memory allocation request to the VMM on behalf of the application (block 322). The VMM may receive the forwarded allocation request (block 330) and in response, allocate the requested memory (block 332). Once the memory is allocated, the VMM may return a pointer to the allocated region of memory to the OS (block 334). In response to receiving a pointer to the allocated region of memory from the VMM (block 340), the OS may request installation of the VMLET (block 342). The VMM may receive the installation request (block 350) and in response, install the requested VMLET (block 352). Once the VMLET is installed, the VMM may return a completion message to the OS (block 354). In response to receiving the completion message (block 360), the OS may return a handle to the application for use in accessing the VMLET (block 362). Once the application receives the handle (block 370), execution of other code by the application may proceed (block 372), completing the creation of the VMLET.

The following pseudo code illustrates one embodiment of code that may be used by an application, an OS, and a VMM to create a VMLET that corresponds to process 300 as shown in FIG. 3.

```
APPLICATION CODE
Void myapp(somevar) {
    Handle* my_vmlet = create_vmlet(int sizeOfVmletInBytes,
    void* func_ptr);
    ...
    // more code
}
OS CODE
Handle* retHand = create_vmlet(int sizeOfVmlet, void*
function_pointer) {
```

| | |
|---|---|
| Vm_malloc(sizeOfVmlet); | //call into VMM |
| Vm_installFuncPtr(function_pointer); | //call into VMM |
| ... | |
| // more code | |
| return return_Handle; | |
| } | |
| VMM CODE | |
| Vm_malloc(sizeOfVmlet); | //create a memory region to |
| | install func_ptr |
| Vm_installFuncPtr(function_pointer); | // install function into |
| | memory |

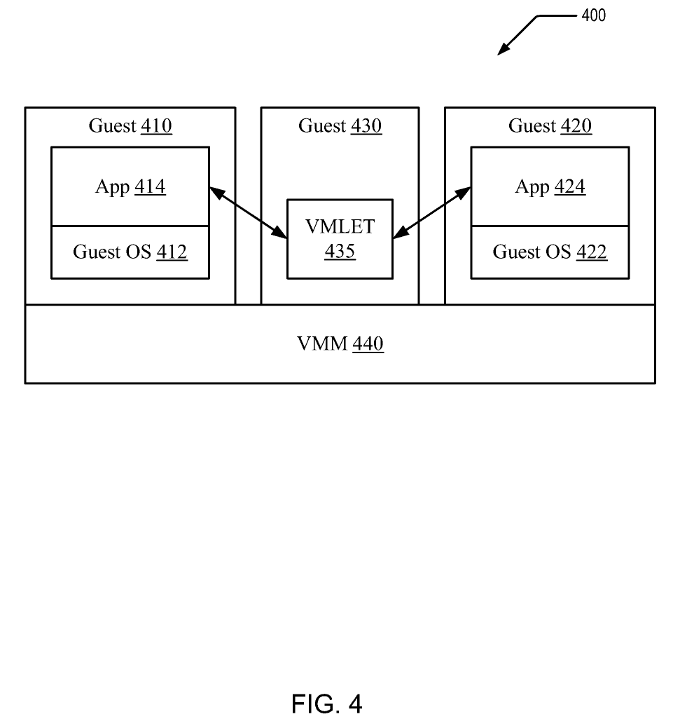

FIG. 4 illustrates one embodiment of computer system 400 that uses virtualization and a VMLET to share a region of memory between applications executing in different OS contexts. System 400 includes a VMM 440 that manages guests 410, 420, and 430. Guest 410 includes a guest OS 412 running an application 414. Guest 420 includes a guest OS 422 running an application 424. Guest 430 includes a VMLET 435 that is created by either application 414 or application 424.

During operation, in one embodiment, VMLET 435 may be used to store data for either application 414 or application 424. Accordingly, the region of memory managed via VMLET 435 may be shared between applications 414 and 424. Data that is stored in the region of memory managed via VMLET 435 may be protected from malicious attacks on either of applications 414 and 424 by the facilities provided by VMM 440. In addition, data that is stored in the region of memory managed via VMLET 435 may survive a reboot of either OS 412 or OS 422. In one embodiment, application 424 may function as a backup for application 414, reusing data stored by VMLET 435. In the event of a failure that affects application 414, application 424 may take over for application 414 without the need to re-load or regenerate needed data that is stored by VMLET 425.

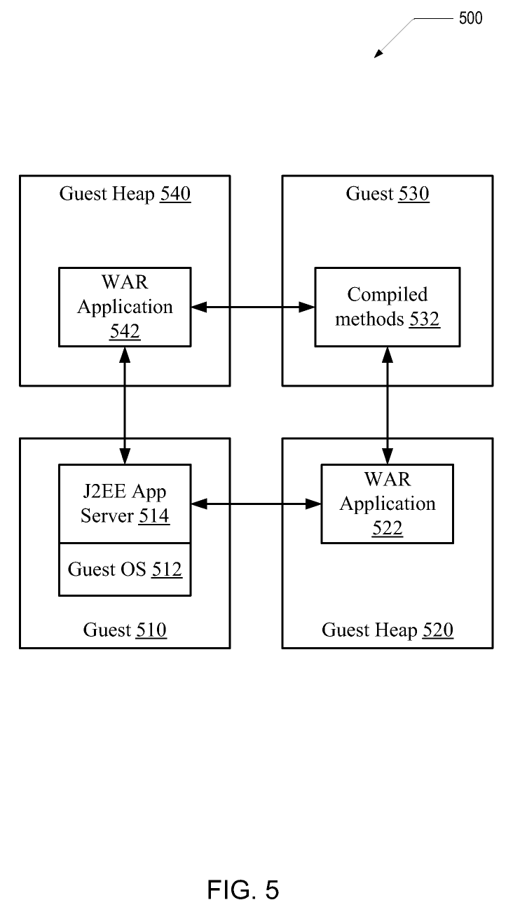

FIG. 5 illustrates one embodiment of computer system 500 that uses virtualization and VMLETs to share code between different applications. System 500 includes guests 510, 520, 530, and 540 that are managed by a VMM (not shown). Guest 5410 includes a guest OS 512 running an application 514. Guest 520 includes a VMLET 522. Guest 530 includes a VMLET 532. Guest 540 includes a VMLET 542. In one embodiment, application 514 may be a J2EE application server, VMLETs 522 and 542 may be Web Archive (WAR) application files, and VMLET 532 may include compiled methods that may be used by both WAR applications 522 and 542. In one embodiment, each of VMLETs 522 and 542 may be created in a separate virtualized memory heap. If either WAR application fails while the J2EE application server continues to run, the failed WAR application may be restarted without the need to recreate the complied methods of VMLET 532

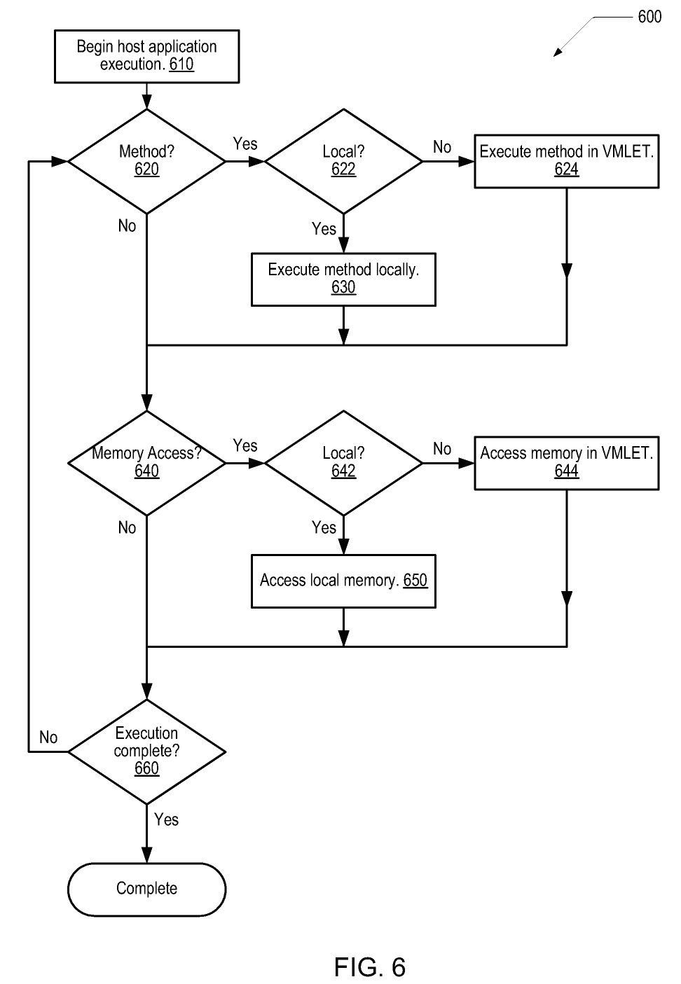

FIG. 6 illustrates one embodiment of a process 600 that may be used to access VMLETs in a virtualized environment. Process 600 may begin with the start of execution of a host application (block 610). If the next instructions to be executed by host application 610 include a method (decision block 620) and if the method is part of the host application (decision block 622), the method may be executed locally, i.e., within the virtual context of the host application (block 630). If the method is not part of the host application (decision block 622), the method may be executed in the context of a VMLET (block 624). After execution of the method, if the next instructions to be executed by host application 610 include a memory access (decision block 640) and if the memory to be accessed is located in the context of the host application (decision block 642), the host application may access the memory locally (block 650). If the memory to be accessed is not located in the context of the host application (decision block 642), the host application may access the memory via a VMLET (block 644). After execution of the memory access, if execution of the host application is complete (decision block 660) process 600 may be complete. If execution of the host application is not complete (decision block 660), process 600 may continue at decision block 620.

### Computer Accessible Storage Medium

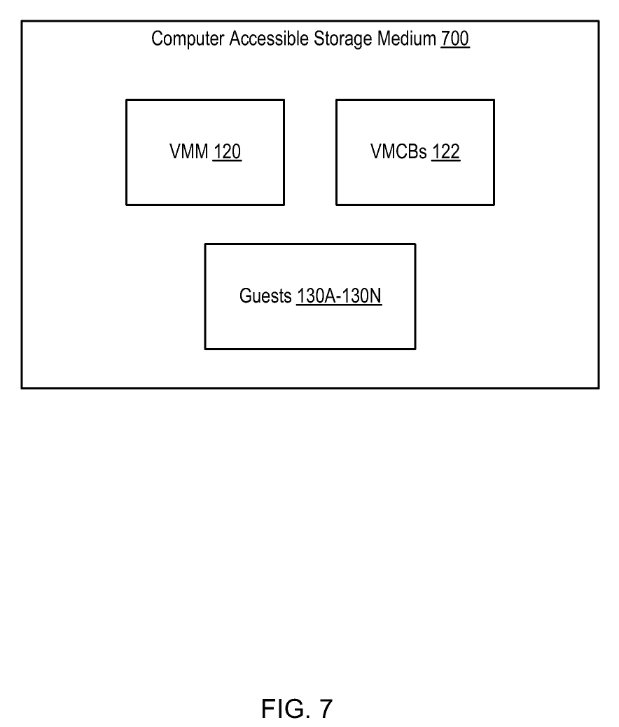

Turning now to FIG. 7, a block diagram of a computer accessible storage medium 700 is shown. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, or DVD-ROM, CD-R, CD-RW, DVD-R, DVD-RW, volatile or non-volatile memory media such as RAM (e.g. synchronous dynamic RAM (SDRAM), Rambus DRAM (RDRAM), static RAM (SRAM), etc.), ROM, Flash memory, non-volatile memory (e.g. Flash memory) accessible via a peripheral interface such as the Universal Serial Bus (USB) interface, etc. The computer accessible storage medium 700 may also include storage media accessible via transmission media such as a network and/or a wireless link. The computer accessible storage medium 700 in FIG. 7 may store one or more of the VMM 120, one or more VMCBs 122, and/or guests 130A-130N. The VMM 120 may comprise instructions which implement the operations described for the VMM 120 herein. Generally, the computer accessible medium 700 may store any set of instructions which, when executed, implement a portion or all of the operations shown in FIGS. 3 and 6. The computer accessible storage medium 700 may, in some embodiments, be part of the host hardware 110.

It is noted that the foregoing flow charts are for purposes of discussion only. In alternative embodiments, the elements depicted in the flow charts may occur in a different order, or in some cases concurrently. Additionally, some of the flow chart elements may not be present in various embodiments, or may be combined with other elements. All such alternatives are contemplated.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
enabling two or more virtual machine guests to execute under the control of a virtual machine monitor;
a first virtual machine guest executing a first portion of an application in the context of a first guest operating system; and
the first portion of the application creating a guest virtual machine applet that executes in the context of a second virtual machine guest;
wherein the first portion of the application and the guest virtual machine applet are part of a single application.

2. The method of claim 1, wherein creating a guest virtual machine applet comprises:
the first portion of the application executing a call to the first guest operating system; and
in response to receiving the call from the first portion of the application, the first guest operating system making system calls to the virtual machine monitor.

3. The method of claim 1, wherein the guest virtual machine applet comprises executable code that is associated with the single application.

4. The method of claim 3, further comprising:
a second virtual machine guest executing a second portion of the application in the context of a second guest operating system; and
the first and second portions of the application sharing executable code within the guest virtual machine applet.

5. The method of claim 1, wherein the guest virtual machine applet comprises data storage that is associated with the single application.

6. The method of claim 5, further comprising:
a second virtual machine guest executing a second portion of the application in the context of a second guest operating system; and
the first and second portions of the application sharing data stored by the guest virtual machine applet.

7. The method of claim 1, wherein the guest virtual machine applet remains operating without interruption throughout a reboot of the first guest operating system.

8. A processor comprising:
an execution core configured to execute instructions to enable two or more virtual machine guests to execute under the control of a virtual machine monitor;
wherein a first virtual machine guest comprises a first portion of an application executing in the context of a first guest operating system;
wherein the first portion of the application is configured to create a guest virtual machine applet that executes in the context of a second virtual machine guest; and
wherein the first portion of the application and the guest virtual machine applet are part of a single application.

9. The processor of claim 8, wherein creating a guest virtual machine applet comprises:
the first portion of the application executing a call to the first guest operating system; and
in response to receiving the call from the first portion of the application, the first guest operating system making system calls to the virtual machine monitor.

10. The processor of claim 8, wherein the guest virtual machine applet comprises executable code that is associated with the single application.

11. The processor of claim 10,
wherein a second virtual machine guest is configured to execute a second portion of the application in the context of a second guest operating system; and
the first and second portions of the application share executable code within the guest virtual machine applet.

12. The processor of claim 8, wherein the guest virtual machine applet comprises data storage that is associated with the single application.

13. The processor of claim 12,
wherein a second virtual machine guest is configured to execute a second portion of the application in the context of a second guest operating system; and
the first and second portions of the application share data stored by the guest virtual machine applet.

14. The processor of claim 8, wherein the guest virtual machine applet remains operating without interruption throughout a reboot of the first guest operating system.

15. A computer accessible storage medium storing a plurality of instructions which, when executed, cause an execution core of a processor to:
enable two or more virtual machine guests to execute under the control of a virtual machine monitor;
wherein a first virtual machine guest comprises a first portion of an application executing in the context of a first guest operating system;
wherein the first portion of the application is configured to create a guest virtual machine applet that executes in the context of a second virtual machine guest; and
wherein the first portion of the application and the guest virtual machine applet are part of a single application.

16. The computer accessible storage medium of claim 15, wherein creating a guest virtual machine applet comprises:
the first portion of the application executing a call to the first guest operating system; and
in response to receiving the call from the first portion of the application, the first guest operating system making system calls to the virtual machine monitor.

17. The computer accessible storage medium of claim 15, wherein the guest virtual machine applet comprises executable code that is associated with the single application.

18. The computer accessible storage medium of claim 17,
wherein a second virtual machine guest is configured to execute a second portion of the application in the context of a second guest operating system; and
the first and second portions of the application share executable code within the guest virtual machine applet.

19. The computer accessible storage medium of claim 15, wherein the guest virtual machine applet comprises data storage that is associated with the single application.

20. The computer accessible storage medium of claim 19,
wherein a second virtual machine guest is configured to execute a second portion of the application in the context of a second guest operating system; and
the first and second portions of the application share data stored by the guest virtual machine applet.
